(19) United States
(12) Patent Application Publication
(10) Pub. No.: US 2021/0245996 A1
(43) Pub. Date: Aug. 12, 2021

(54) ELEVATOR ROPE TERMINAL STRUCTURE

(71) Applicant: Mitsubishi Electric Corporation, Tokyo (JP)

(72) Inventors: Rikio KONDO, Tokyo (JP); Masayoshi YAMANAKA, Tokyo (JP)

(73) Assignee: Mitsubishi Electric Corporation, Tokyo (JP)

(21) Appl. No.: 16/973,764

(22) PCT Filed: Jul. 20, 2018
(86) PCT No.: PCT/JP2018/027285

§ 371 Date: Dec. 10, 2020

(51) Int. Cl. B66B 7/08; B66B 7/06

(52) U.S. Cl. CPC B66B 7/085; B66B 7/062

(57) ABSTRACT

Provided is an elevator rope terminal structure including an insertion body to be held in contact with an elevator rope having a flat sectional shape. Pressing portions provided to the insertion body are configured to maintain a state in which the insertion body is pressed against the elevator rope. The elevator rope and the insertion body are to be held inside a through hole of a housing. The through hole has an inner surface including a first receiving surface and a second receiving surface which are to be positioned on both sides of the elevator rope in a thickness direction of the elevator rope. A distance between the first receiving surface and the second receiving surface decreases toward a rope passage port of the through hole. The insertion body includes a first insertion member to be arranged between the elevator rope and the first receiving surface.

### TECHNICAL FIELD

The present invention relates to an elevator rope terminal structure provided to an elevator rope.

### BACKGROUND ART

There has hitherto been known an elevator rope terminal end assembly in which a pair of wedge elements configured to sandwich an elevator rope therebetween are held in a wedge housing to hold the elevator rope in the wedge housing. In the related-art elevator rope terminal end assembly described above, a rope end block is mounted to an end portion of the elevator rope so as to prevent the elevator rope from coming off the pair of wedge elements (see, for example, Patent Literature 1).

### CITATION LIST

### Patent Literature

[PTL 1] JP 2014-129182 A

### SUMMARY OF INVENTION

### Technical Problem

In the related-art elevator rope terminal end assembly described in Patent Literature 1, when tension of the elevator rope is lost, the pair of wedge elements may move in a direction of being removed from the wedge housing in some cases. When the pair of wedge elements are removed from the wedge housing, a gap between each of the wedge elements and the elevator rope becomes larger. As a result, it becomes difficult to insert the wedge elements into the housing.

The present invention has been made to solve the problem described above, and has an object to provide an elevator rope terminal structure capable of more reliably ensuring a state in which an insertion body is inserted in a through hole of a housing.

### Solution to Problem

According to the present invention, there is provided an elevator rope terminal structure, including: an insertion body to be held in contact with an elevator rope having a flat sectional shape; pressing portions which are provided to the insertion body, and are configured to maintain a state in which the insertion body is pressed against the elevator rope; and a housing which has a through hole with a rope passage port, and is configured to hold the elevator rope and the insertion body inside the through hole, wherein the elevator rope is allowed to pass from an outside of the housing through the rope passage port to reach an inside of the through hole, wherein the through hole has an inner surface including a first receiving surface and a second receiving surface which are to be located on both sides of the elevator rope in a thickness direction of the elevator rope, wherein a distance between the first receiving surface and the second receiving surface decreases toward the rope passage port, and wherein the insertion body includes a first insertion member to be arranged between the elevator rope and the first receiving surface.

### Advantageous Effects of Invention

According to the elevator rope terminal structure of the present invention, it is possible to more reliably ensure a state in which the insertion body is inserted in the through hole of the housing.

### BRIEF DESCRIPTION OF DRAWINGS

FIG. 1 is a configuration diagram for illustrating an elevator according to a first embodiment of the present invention.

FIG. 2 is a perspective view for illustrating a first terminal structure of FIG. 1.

FIG. 3 is a front view for illustrating the first terminal structure of FIG. 2.

FIG. 4 is a side view for illustrating the first terminal structure of FIG. 2.

FIG. 5 is a side view for illustrating an inside of the first terminal structure of FIG. 4.

FIG. 6 is a perspective view for illustrating the inside of the first terminal structure of FIG. 2.

FIG. 7 is a sectional view taken along the line VII-VII of FIG. 5.

FIG. 8 is a sectional view taken along the line VIII-VIII of FIG. 5.

FIG. 9 is a perspective view for illustrating a first terminal structure corresponding to an elevator rope terminal structure according to a second embodiment of the present invention.

FIG. 10 is a front view for illustrating the first terminal structure of FIG. 9.

FIG. 11 is a side view for illustrating the first terminal structure of FIG. 10.

FIG. 12 is a side view for illustrating an inside of the first terminal structure of FIG. 11.

FIG. 13 is a perspective view for illustrating the inside of the first terminal structure of FIG. 9.

FIG. 14 is a sectional view taken along the line XIV-XIV of FIG. 12.

FIG. 15 is a sectional view taken along the line XV-XV of FIG. 12.

FIG. 16 is a perspective view for illustrating a first terminal structure corresponding to an elevator rope terminal structure according to a third embodiment of the present invention.

FIG. 17 is a front view for illustrating the first terminal structure of FIG. 16.

FIG. 18 is a side view for illustrating the first terminal structure of FIG. 17.

FIG. 19 is a side view for illustrating an inside of the first terminal structure of FIG. 18.

FIG. 20 is a perspective view for illustrating the inside of the first terminal structure of FIG. 16.

FIG. 21 is a sectional view taken along the line XXI-XXI of FIG. 19.

FIG. 22 is a sectional view taken along the line XXII-XXII of FIG. 19.

FIG. 23 is a perspective view for illustrating a first terminal structure corresponding to an elevator rope terminal structure according to a fourth embodiment of the present invention.

FIG. 24 is a front view for illustrating the first terminal structure of FIG. 23.

FIG. 25 is a front view for illustrating an inside of the first terminal structure of FIG. 24.

FIG. 26 is a back view for illustrating the inside of the first terminal structure of FIG. 24.

FIG. 27 is a side view for illustrating the first terminal structure of FIG. 24.

FIG. 28 is a side view for illustrating the inside of the first terminal structure of FIG. 27.

FIG. 29 is a perspective view for illustrating the inside of the first terminal structure of FIG. 23.

FIG. 30 is a sectional view taken along the line XXX-XXX of FIG. 28.

FIG. 31 is a sectional view taken along the line XXXI-XXXI of FIG. 28.

FIG. 32 is a sectional view taken along the line XXXII-XXXII of FIG. 26.

FIG. 33 is a perspective view for illustrating a first terminal structure corresponding to an elevator rope terminal structure according to a fifth embodiment of the present invention.

FIG. 34 is a perspective view for illustrating a state in which the first terminal structure of FIG. 33 is viewed from another side.

FIG. 35 is a front view for illustrating the first terminal structure of FIG. 33.

FIG. 36 is a side view for illustrating the first terminal structure when viewed from the left side of FIG. 35.

FIG. 37 is a side view for illustrating an inside of the first terminal structure of FIG. 36.

FIG. 38 is a side view for illustrating the first terminal structure when viewed from the right side of FIG. 35.

FIG. 39 is a side view for illustrating the inside of the first terminal structure of FIG. 38.

FIG. 40 is a perspective view for illustrating the inside of the first terminal structure of FIG. 33.

FIG. 41 is a perspective view for illustrating the inside of the first terminal structure of FIG. 34.

FIG. 42 is a sectional view taken along the line XXXXII-XXXXII of FIG. 39.

FIG. 43 is a sectional view taken along the line XXXXIII-XXXXIII of FIG. 39.

### DESCRIPTION OF EMBODIMENTS

Now, embodiments of the present invention are described with reference to the drawings.

### First Embodiment

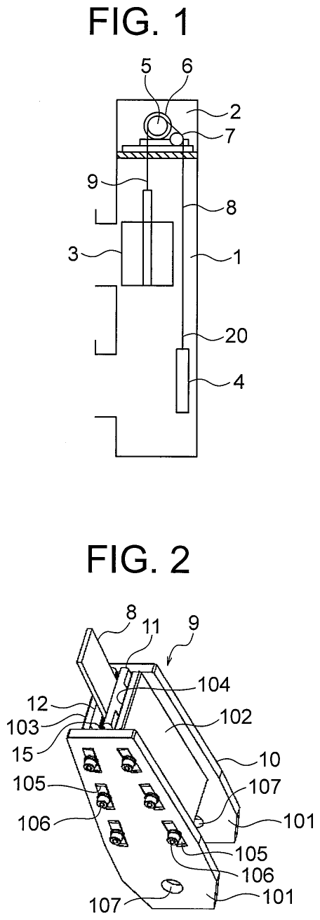

FIG. 1 is a configuration diagram for illustrating an elevator according to a first embodiment of the present invention. In FIG. 1, a car 3 and a counterweight 4 are provided in a hoistway 1. The car 3 and the counterweight 4 are elevating bodies that are movable in a vertical direction inside the hoistway 1. A machine room 2 is provided above the hoistway 1.

A hoisting machine 6 and a deflector sheave 7 are provided in the machine room 2. The hoisting machine 6 is a driving device configured to generate a driving force for moving the car 3 and the counterweight 4 in the vertical direction. Further, the hoisting machine 6 includes a driving sheave 5 to be rotated by the driving force of the hoisting machine 6. The deflector sheave 7 is arranged apart from the driving sheave 5.

A plurality of elevator ropes 8 are wound around the driving sheave 5 and the deflector sheave 7. Examples of the elevator rope 8 include an elongated object formed by twisting a plurality of fibers together and an elongated object formed by impregnating a plurality of fibers with a resin. Each of the elevator ropes 8 has a flat sectional shape. Specifically, each of the elevator ropes 8 is a belt having a flat cross section. The car 3 and the counterweight 4 are suspended by the elevator ropes 8 in the hoistway 1. The car 3 and the counterweight 4 are moved in the vertical direction in accordance with rotation of the driving sheave 5.

A first terminal structure 9 corresponding to an elevator rope terminal structure is provided to a first end portion of each of the elevator ropes 8. A second terminal structure 20 corresponding to the elevator rope terminal structure is provided to a second end portion of each of the elevator ropes 8. Each of the first terminal structures 9 is connected to a top of the car 3. Each of the second terminal structures 20 is connected to a top of the counterweight 4. Through the connections described above, in this example, the car 3 and the counterweight 4 are suspended in a 1:1 roping system. A configuration of each of the second terminal structures 20 is the same as a configuration of each of the first terminal structures 9.

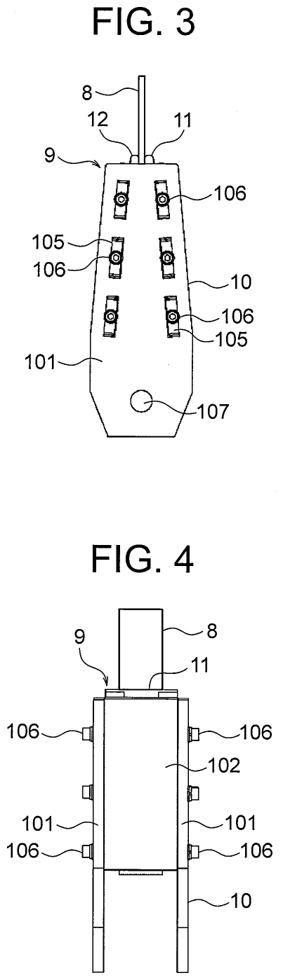

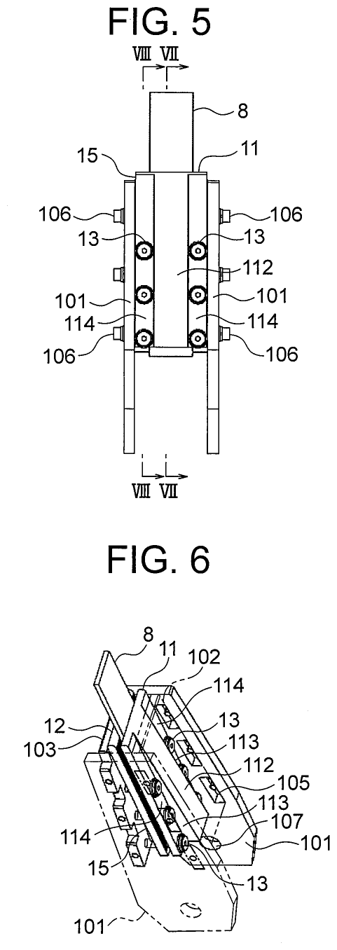

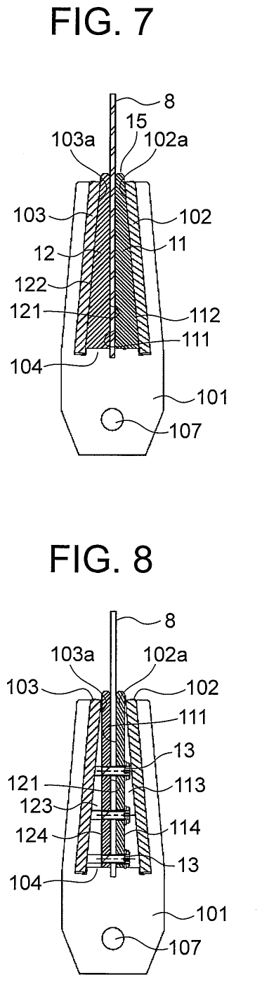

FIG. 2 is a perspective view for illustrating the first terminal structure 9 of FIG. 1. FIG. 3 is a front view for illustrating the first terminal structure 9 of FIG. 2. FIG. 4 is a side view for illustrating the first terminal structure 9 of FIG. 2. FIG. 5 is a side view for illustrating an inside of the first terminal structure 9 of FIG. 4. FIG. 6 is a perspective view for illustrating the inside of the first terminal structure 9 of FIG. 2. FIG. 7 is a sectional view taken along the line VII-VII of FIG. 5. FIG. 8 is a sectional view taken along the line VIII-VIII of FIG. 5.

The first terminal structure 9 includes an insertion body 15, a plurality of screws 13, and a housing 10. The insertion body 15 is to be held in contact with the elevator rope 8. The plurality of screws 13 correspond to pressing portions configured to hold the insertion body 15 over the elevator rope 8. The housing 10 is configured to receive the elevator rope 8 and the insertion body 15.

The housing 10 includes a pair of parallel plates 101, a first receiving plate 102, and a second receiving plate 103. The pair of parallel plates 101 are arranged in parallel to each other. The first receiving plate 102 and the second receiving plate 103 are arranged between the pair of parallel plates 101 so as to face each other. The first receiving plate 102 is fixed to each of the pair of parallel plates 101. The second receiving plate 103 is also fixed to each of the pair of parallel plates 101. That is, the housing 10 is formed by combining the pair of parallel plates 101, the first receiving plate 102, and the second receiving plate 103.

A through hole 104 surrounded by the pair of parallel plates 101, the first receiving plate 102, and the second receiving plate 103 is defined in the housing 10. The through hole 104 passes through the housing 10. Thus, the through hole 104 has a rope passage port being a first opening portion and an insertion body port being a second opening portion. The rope passage port of the through hole 104 is formed in a distal end portion of the housing 10 in a longitudinal direction of the housing 10. Further, the insertion body port of the through hole 104 is formed in an intermediate portion of the housing 10 in the longitudinal direction. The elevator rope 8 and the insertion body 15 are held in the through hole 104.

The through hole 104 has an inner surface including, as illustrated in FIG. 7 and FIG. 8, a first receiving surface 102a and a second receiving surface 103a. The first receiving surface 102a is formed by the first receiving plate 102. The second receiving surface 103a is formed by the second receiving plate 103. The first receiving surface 102a and the second receiving surface 103a face each other in a width direction of the through hole 104. A distance between the first receiving surface 102a and the second receiving surface 103a continuously decreases from the insertion body port of the through hole 104 toward the rope passage port of the through hole 104. In this example, each of the first receiving surface 102a and the second receiving surface 103a is inclined with respect to an axis of the housing 10.

A plurality of elongated holes 105 are formed in each of the parallel plates 101. The plurality of elongated holes 105 are formed at positions spaced apart from each other along the first receiving plate 102 and at positions spaced apart from each other along the second receiving plate 103. The first receiving plate 102 and the second receiving plate 103 are fixed to the parallel plates 101 with use of a plurality of fixing screws 106 inserted through the elongated holes 105, respectively. Positions of the first receiving plate 102 and the second receiving plate 103 with respect to the pair of parallel plates 101 can be adjusted by adjusting positions of the fixing screws 106 in the elongated holes 105.

A mounting hole 107 is formed in each of the parallel plates 101. Each of the mounting holes 107 is positioned in a rear end portion of the housing 10 in the longitudinal direction. The first terminal structure 9 is connected to the car 3 through intermediation of a mounting member inserted through the mounting holes 107 of the first terminal structure 9. Meanwhile, the second terminal structure 20 is connected to the counterweight 4 through intermediation of a mounting member inserted through mounting holes of the second terminal structure 20.

The elevator rope 8 is allowed to pass from an outside of the housing 10 through the rope passage port of the through hole 104 to reach an inside of the through hole 104. The elevator rope 8 has a first rope surface and a second rope surface, which extend along a width direction of the elevator rope 8. The first rope surface and the second rope surface are formed on sides opposite to each other in a thickness direction of the elevator rope 8. The elevator rope 8 is inserted into the through hole 104 under a state in which the first rope surface faces the first receiving surface 102a and the second rope surface faces the second receiving surface 103a. As a result, the first receiving surface 102a and the second receiving surface 103a are arranged on both sides of the elevator rope 8 in the thickness direction.

The insertion body 15 includes a first insertion member 11 and a second insertion member 12. The first insertion member 11 is arranged between the elevator rope 8 and the first receiving surface 102a. The second insertion member 12 is arranged between the elevator rope 8 and the second receiving surface 103a. The first insertion member 11 and the second insertion member 12 sandwich the elevator rope 8 in the thickness direction of the elevator rope 8.

The first insertion member 11 is arranged under a state in which a longitudinal direction of the first insertion member 11 matches a longitudinal direction of the elevator rope 8 and a width direction of the first insertion member 11 matches the width direction of the elevator rope 8. A thickness direction of the first insertion member 11 matches the thickness direction of the elevator rope 8.

The second insertion member 12 is arranged under a state in which a longitudinal direction of the second insertion member 12 matches the longitudinal direction of the elevator rope 8 and a width direction of the second insertion member 12 matches the width direction of the elevator rope 8. A thickness direction of the second insertion member 12 matches the thickness direction of the elevator rope 8. In this example, each of a dimension of the first insertion member 11 in the width direction and a dimension of the second insertion member 12 in the width direction is larger than a dimension of the elevator rope 8 in the width direction.

The first insertion member 11 has a first rope-side opposing surface 111 and a first housing-side opposing surface 112. The first housing-side opposing surface 112 is formed on a side opposite to the first rope-side opposing surface 111 in the thickness direction of the first insertion member 11. A distance between the first rope-side opposing surface 111 and the first housing-side opposing surface 112 continuously decreases from the insertion body port of the through hole 104 toward the rope passage port of the through hole 104. As a result, the first insertion member 11 has a wedge-like shape.

A pair of first stepped portions 113 are formed in both end portions of the first insertion member 11 in the width direction so as to extend along the longitudinal direction of the elevator rope 8. The pair of first stepped portions 113 are arranged on both sides of the first housing-side opposing surface 112 in a width direction thereof. Each of the first stepped portions 113 is a recessed portion, which is recessed from the first housing-side opposing surface 112 side toward the first rope-side opposing surface 111.

Further, in the first insertion member 11, bottom surfaces of the pair of first stepped portions 113 are formed as first pressurizing surfaces 114 so as to extend along the longitudinal direction of the elevator rope 8. Thus, a position of each of the first pressurizing surfaces 114 is closer to the first rope-side opposing surface 111 than a position of the first housing-side opposing surface 112. Each of the first pressurizing surfaces 114 is parallel to the first rope-side opposing surface 111.

The first rope-side opposing surface 111 is in contact with the first rope surface of the elevator rope 8. The first housing-side opposing surface 112 is in contact with the first receiving surface 102a. Each of the first pressurizing surfaces 114 is apart from the inner surface of the through hole 104. As a result, a space is formed between each of the first pressurizing surfaces 114 and the inner surface of the through hole 104.

The second insertion member 12 has a second rope-side opposing surface 121 and a second housing-side opposing surface 122. The second housing-side opposing surface 122 is formed on a side opposite to the second rope-side opposing surface 121 in the thickness direction of the second insertion member 12. A distance between the second rope-side opposing surface 121 and the second housing-side opposing surface 122 continuously decreases from the insertion body port of the through hole 104 toward the rope passage port of the through hole 104. As a result, the second insertion member 12 has a wedge-like shape.

A pair of second stepped portions 123 are formed in both end portions of the second insertion member 12 in the width direction so as to extend along the longitudinal direction of the elevator rope 8. The pair of second stepped portions 123 are arranged on both sides of the second housing-side opposing surface 122 in a width direction thereof. Each of the second stepped portions 123 is a recessed portion, which is recessed from the second housing-side opposing surface 122 side toward the second rope-side opposing surface 121.

Further, in the second insertion member 12, bottom surfaces of the pair of second stepped portions 123 are formed as second pressurizing surfaces 124 so as to extend along the longitudinal direction of the elevator rope 8. Thus, a position of each of the second pressurizing surfaces 124 is closer to the second rope-side opposing surface 121 than a position of the second housing-side opposing surface 122. Each of the second pressurizing surfaces 124 is parallel to the second rope-side opposing surface 121.

The second rope-side opposing surface 121 is in contact with the second rope surface of the elevator rope 8. The second housing-side opposing surface 122 is in contact with the second receiving surface 103a. Each of the second pressurizing surfaces 124 is apart from the inner surface of the through hole 104. As a result, a space is formed between each of the second pressurizing surfaces 124 and the inner surface of the through hole 104.

A plurality of run-through holes passing from the first pressurizing surfaces 114 to reach the first rope-side opposing surface 111 are formed in the first insertion member 11. The plurality of run-through holes are formed so as to be spaced apart from each other in the longitudinal direction of the first insertion member 11. A plurality of threaded holes passing from the second pressurizing surfaces 124 to reach the second rope-side opposing surface 121 are formed in the second insertion member 12. The plurality of threaded holes are formed so as to be spaced apart from each other in the longitudinal direction of the second insertion member 12.

The screws 13 are provided to the insertion body 15. Further, the screws 13 are mounted into the threaded holes of the second insertion member 12 under a state in which the screws 13 are inserted through the run-through holes of the first insertion member 11. The screws 13 are arranged so as to be spaced apart from each other in the longitudinal direction of the insertion body 15. Further, the screws 13 are arranged within a set range of the insertion body 15 in the longitudinal direction of the insertion body 15. In this example, the set range in which the screws 13 are arranged corresponds to a range from a rear end portion of the insertion body 15 in the longitudinal direction to a position closer to a distal end portion of the insertion body 15 in the longitudinal direction with respect to a center position of the insertion body 15.

Further, as illustrated in FIG. 5, the screws 13 are arranged at positions outside a region of the elevator rope 8 when viewed along the thickness direction of the elevator rope 8. With the arrangement described above, the screws 13 are arranged without passing through the elevator rope 8. Further, the screws 13 are tightened into the threaded holes of the second insertion member 12. The screws 13 fasten the elevator rope 8 and the insertion body 15 together under a state in which the screws 13 are tightened into the threaded holes of the second insertion member 12.

The screws 13 fasten the elevator rope 8 and the insertion body 15 together to press the insertion body 15 against the elevator rope 8. In this manner, each of the screws 13 applies a pressing force to the insertion body 15 at a position outside the region of the elevator rope 8 when viewed along the thickness direction of the elevator rope 8. Further, each of the screws 13 applies the pressing force to the insertion body 15 in a direction of causing the first insertion member 11 and the second insertion member 12 to approach each other. The elevator rope 8 is held between the first insertion member 11 and the second insertion member 12 with the pressing forces applied to the insertion body 15 through the tightening of the screws 13.

Head portions of the screws 13 are arranged in spaces between the inner surface of the through hole 104 and the first pressurizing surfaces 114. Further, the head portions of the screws 13 apply the pressing forces for pressing the insertion body 15 against the elevator rope 8 to the first pressurizing surfaces 114 through the tightening of the screws 13 into the threaded holes of the second insertion member 12.

The screws 13 maintain a state of fastening the elevator rope 8 and the insertion body 15 together to maintain a state in which the insertion body 15 is pressed against the elevator rope 8. In this manner, the insertion body 15 is integrated with the elevator rope 8. Thus, a state in which the insertion body 15 is held over the elevator rope 8 is maintained regardless of whether or not the insertion body 15 is inserted in the through hole 104.

The elevator rope 8 and the insertion body 15 are held between the first receiving surface 102a and the second receiving surface 103a. In the insertion body 15, the first insertion member 11 is not fixed to the second insertion member 12, and the first insertion member 11 and the second insertion member 12 are allowed to move in a direction of approaching each other. Thus, as the insertion body 15 moves toward the rope passage port of the through hole 104 with the elevator rope 8 being pulled, the first insertion member 11 and the second insertion member 12 move in the direction of approaching each other while being guided along the first receiving surface 102a and the second receiving surface 103a. As a result, as the insertion body 15 moves toward the rope passage port of the through hole 104 with the elevator rope 8 being pulled, a magnitude of the pressing forces for pressing the insertion body 15 against the elevator rope 8 is increased.

In the first terminal structure 9 and the second terminal structure 20 described above, the state in which the insertion body 15 is pressed against the elevator rope 8 having a flat sectional shape is maintained with use of the plurality of screws 13. Thus, the state in which the insertion body 15 is held over the elevator rope 8 can be maintained regardless of the presence or absence of the housing 10.

For example, in a case in which the elevator ropes 8 are handled at the time of installation work for the elevator, when the car 3 is subjected to an impact at the time of an emergency stop of the car 3 to swing the elevator ropes 8, each of the elevator ropes 8 may lose tension in some cases. In this case, there is a fear in that the insertion body 15 may come off through the insertion body port of the through hole 104. In this embodiment, even when the insertion body 15 comes off the housing 10, the state in which the insertion body 15 is held over the elevator rope 8 can be maintained, and thus the insertion body 15 can easily be inserted into the through hole 104 of the housing 10. Thus, a state in which the insertion body 15 is inserted in the through hole 104 of the housing 10 can be more reliably ensured.

Further, the insertion body 15 includes the first insertion member 11, which is arranged between the elevator rope 8 and the first receiving surface 102a, and the second insertion member 12, which is arranged between the elevator rope 8 and the second receiving surface 103a. Thus, the elevator rope 8 can be held between the first insertion member 11 and the second insertion member 12. As a result, the state in which the insertion body 15 is held over the elevator rope 8 can easily be maintained. Further, even when the insertion body 15 comes off the housing 10, the elevator rope 8 can be made less liable to come off the insertion body 15.

Further, in the first insertion member 11, the distance between the first housing-side opposing surface 112 and the first rope-side opposing surface 111 decreases toward the rope passage port of the through hole 104. Thus, the first insertion member 11 can easily be inserted into the through hole 104. Further, a contact area of the first insertion member 11 with each of the elevator rope 8 and the first receiving surface 102a can be increased. As a result, the state in which the elevator rope 8 and the insertion body 15 are held inside the through hole 104 can be more reliably maintained.

Further, in the second insertion member 12, the distance between the second housing-side opposing surface 122 and the second rope-side opposing surface 121 decreases toward the rope passage port of the through hole 104. Thus, the second insertion member 12 can easily be inserted into the through hole 104. Further, a contact area of the second insertion member 12 with each of the elevator rope 8 and the second receiving surface 103a can be increased. As a result, the state in which the elevator rope 8 and the insertion body 15 are held inside the through hole 104 can be more reliably maintained.

Further, each of the first insertion member 11 and the second insertion member 12 is formed to have a wedge-like shape. In this manner, the first insertion member 11 and the second insertion member 12 can have the same shape. As a result, a common shape can be used for components, and hence the number of kinds of components can be reduced. Further, a position of the elevator rope 8 inside the through hole 104 can be set closer to an axis of the through hole 104. As a result, imbalance in force applied to the housing 10 when the housing 10 is pulled by the elevator rope 8 can be reduced.

Further, each of the screws 13 applies the pressing force to the insertion body 15 in the direction of causing the first insertion member 11 and the second insertion member 12 approach each other. Thus, the elevator rope 8 can be held between the first insertion member 11 and the second insertion member 12. As a result, the state in which the insertion body 15 is held over the elevator rope 8 can easily be maintained.

Further, the insertion body 15 has the first pressurizing surfaces 114 that are apart from the inner surface of the through hole 104. Further, the head portions of the screws 13 apply the pressing forces for pressing the insertion body 15 against the elevator rope 8 to the first pressurizing surfaces 114. Thus, the head portions of the screws 13 can be arranged in the spaces formed between the inner surface of the through hole 104 and the first pressurizing surfaces 114. In this manner, interference of the screws 13 with the inner surface of the through hole 104 can be avoided.

Further, the first pressurizing surfaces 114 are the bottom surfaces of the first stepped portions 113 corresponding to the recessed portions formed in the insertion body 15. Thus, the space can be more reliably formed between the inner surface of the through hole 104 and each of the first pressurizing surfaces 114.

Further, the first stepped portions 113 are formed in the insertion body 15 so as to extend along the longitudinal direction of the elevator rope 8. Thus, the insertion body 15 can be pressed against the elevator rope 8 along the longitudinal direction of the elevator rope 8. In this manner, the insertion body 15 can be more reliably held over the elevator rope 8.

Further, the screws 13 are arranged at the positions outside the region of the elevator rope 8 when viewed along the thickness direction of the elevator rope 8, and apply the pressing forces to the insertion body 15. Thus, the pressing forces can be applied to the insertion body 15 without passage of the screws 13 through the elevator rope 8. As a result, work for forming holes for passage of the screws 13 therethrough in the elevator rope 8 can be eliminated.

A dimension of the insertion body 15 in a width direction of the insertion body 15 is larger than the dimension of the elevator rope 8 in the width direction of the elevator rope 8. Thus, even when a position of the elevator rope 8 with respect to the insertion body 15 is shifted in the width direction of the elevator rope 8, the insertion body 15 can be more reliably pressed against the elevator rope 8.

Further, the screws 13 fasten the elevator rope 8 and the insertion body 15 together to press the insertion body 15 against the elevator rope 8. Thus, the state in which the insertion body 15 is pressed against the elevator rope 8 can be maintained with a simple configuration.

Further, the housing 10 is formed by combining the pair of parallel plates 101, the first receiving plate 102, and the second receiving plate 103 with use of the fixing screws 106. Thus, the housing 10 can be manufactured with use of general-purpose plate members and general-purpose screws. As a result, casting work and welding work at the time of manufacture of the housing 10 are not required. Thus, the housing 10 can easily be manufactured within a short period of time. Further, the housing 10 having special specifications, which cannot be mass-produced, can also easily be manufactured.

### Second Embodiment

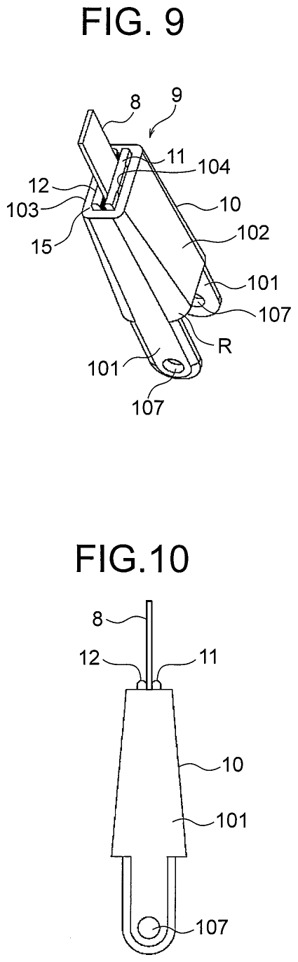

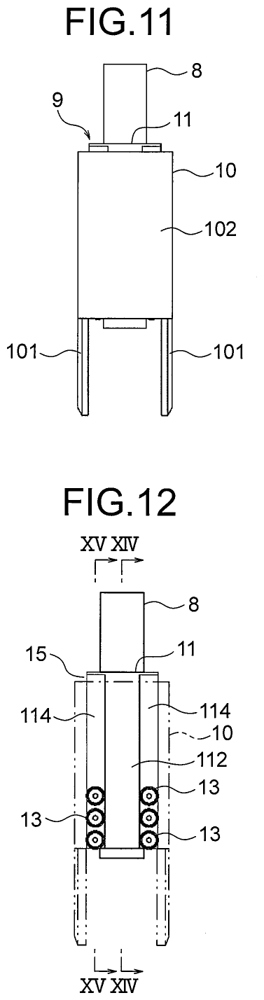

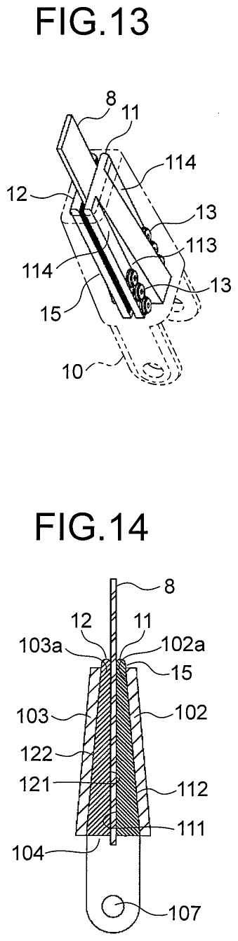

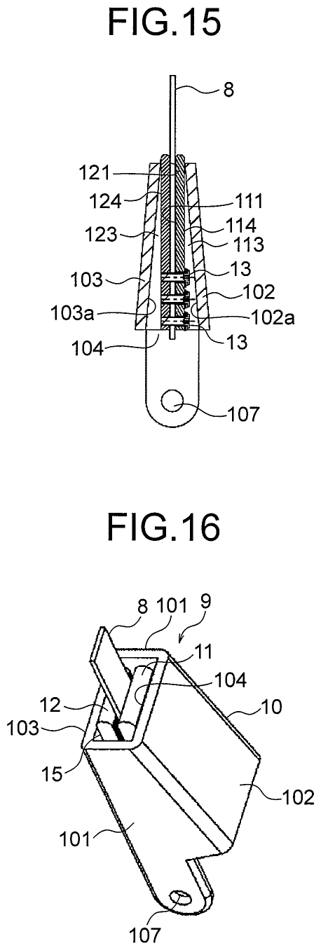

FIG. 9 is a perspective view for illustrating the first terminal structure 9 corresponding to an elevator rope terminal structure according to a second embodiment of the present invention. FIG. 10 is a front view for illustrating the first terminal structure 9 of FIG. 9. FIG. 11 is a side view for illustrating the first terminal structure 9 of FIG. 10. FIG. 12 is a side view for illustrating an inside of the first terminal structure 9 of FIG. 11. FIG. 13 is a perspective view for illustrating the inside of the first terminal structure 9 of FIG. 9. FIG. 14 is a sectional view taken along the line XIV-XIV of FIG. 12. FIG. 15 is a sectional view taken along the line XV-XV of FIG. 12.

The housing 10 is a single member. Specifically, the pair of parallel plates 101, the first receiving plate 102, and the second receiving plate 103 of the housing 10 are formed by integral molding so as to be disassemblable. In this example, the housing 10 is a cast molded member. Boundaries of the first receiving plate 102 and the second receiving plate 103 with the parallel plates 101 correspond to four corners of the housing 10. Curved-surface portions R are formed at the four corners of the housing 10.

The screws 13 corresponding to the pressing portions are arranged only within the set range of the insertion body 15 in the longitudinal direction. The set range in which the screws 13 are arranged is a range on a rear end portion side of the insertion body 15 in the longitudinal direction with respect to the center position of the insertion body 15 in the longitudinal direction. Specifically, the screws 13 are arranged only in one of two ranges formed by halving a range of the insertion body 15 in the longitudinal direction, which is farther from the rope passage port of the through hole 104. Thus, the pressing forces for pressing the insertion body 15 against the elevator rope 8 are applied to the first pressuring surfaces 114 over the set range that is apart from the rope passage port of the through hole 104. A configuration of the second terminal structure 20 corresponding to the elevator rope terminal structure is the same as the configuration of the first terminal structure 9. Other configurations are the same as those in the first embodiment.

In each of the first terminal structure 9 and the second terminal structure 20 described above, the housing 10 is a single member. Thus, the strength of the housing 10 can be improved as compared with that in the first embodiment, and hence reduction in weight and size of the housing 10 can be achieved.

Further, the set range in which the screws 13 are arranged is set on the rear end portion side of the insertion body 15 in the longitudinal direction with respect to the center position of the insertion body 15 in the longitudinal direction. Thus, the spaces in which the head portions of the screws 13 are arranged can be more reliably secured. Specifically, the space between each of the first pressurizing surfaces 114 and the first receiving surface 102a and the space between each of the second pressurizing surfaces 124 and the second receiving surface 103a increase toward the rear end portion of the insertion body 15 in the longitudinal direction. In this manner, the screws 13 are arranged so as to concentrate at positions on the rear end portion side of the insertion body 15 in the longitudinal direction. As a result, the spaces in which the head portions of the screws 13 are arranged can be increased. Thus, interference of the head portions of the screws 13 with the inner surface of the through hole 104 can be more reliably avoided. Further, in this case, use of nuts can be eliminated by forming run-through holes, through which the screws 13 are inserted, in one of the first insertion member 11 or the second insertion member 12 and forming threaded holes, into which the screws 13 are mounted, in the other one of the first insertion member 11 or the second insertion member 12.

Further, an angle of the first housing-side opposing surface 112 with respect to the first rope-side opposing surface 111 is defined as an angle of a distal end portion of the first insertion member 11 in the longitudinal direction, and an angle of the second housing-side opposing surface 122 with respect to the second rope-side opposing surface 121 is defined as an angle of a distal end portion of the second insertion member 12 in the longitudinal direction. In this case, the set range in which the screws 13 are arranged in a concentrated manner is set on the rear end portion side of the insertion body 15 in the longitudinal direction. As a result, each of the angle of the distal end portion of the first insertion member 11 in the longitudinal direction and the angle of the distal end portion of the second insertion member 12 in the longitudinal direction can be reduced. In this manner, the insertion member 15 can be more deeply inserted between the first receiving surface 102a and the second receiving surface 103a toward the rope passage port of the through hole 104, and hence the insertion body 15 can be made less liable to come off the through hole 104.

Further, a distribution of a magnitude of the pressing forces for pressing the insertion body 15 against the elevator rope 8 can be set so as to decrease from the rear end portion of the insertion body 15 in the longitudinal direction toward the distal end portion thereof in the longitudinal direction. As a result, concentration of a force on the elevator rope 8 at a boundary between a portion of the elevator rope 8, against which the insertion body 15 is pressed, and a portion of the elevator rope 8, which is exposed from the insertion body 15, can be reduced. Thus, breaking of the elevator rope 8 at the distal end portion of the insertion body 15 in the longitudinal direction can be prevented.

Specifically, a position of the distal end portion of the insertion body 15 in the longitudinal direction corresponds to a boundary position between a portion of the elevator rope 8, which is held in the insertion body 15, and a portion of the elevator rope 8, which is not held in the insertion body 15. Thus, when the elevator rope 8 swings, or an angle at which the elevator rope 8 is pulled changes, fatigue of the elevator rope 8 is accelerated at the position of the distal end portion of the insertion body 15 in the longitudinal direction, which may lead to a fear of breaking the elevator rope 8. In this embodiment, the distribution of the magnitude of the pressing forces for pressing the insertion body 15 against the elevator rope 8 decreases toward the distal end portion of the insertion body 15 in the longitudinal direction. Thus, the fatigue of the elevator rope 8 at the position of the distal end portion of the insertion body 15 in the longitudinal direction can be suppressed.

In the first and second embodiments, the screws 13 inserted through the run-through holes of the first insertion member 11 are mounted into the threaded holes of the second insertion member 12. However, a plurality of threaded holes passing from the first pressurizing surfaces 114 to reach the first rope-side opposing surface 111 may be formed in the first insertion member 11, and a plurality of run-through holes passing from the second pressurizing surfaces 124 to reach the second rope-side opposing surface 121 may be formed in the second insertion member 12. In this case, the screws 13 are mounted into the threaded holes of the first insertion member 11 under a state in which the screws 13 are inserted through the run-through holes of the second insertion member 12. In this case, the head portions of the screws 13 are arranged in the spaces between the inner surface of the through hole 104 and the second pressurizing surfaces 124. When the screws 13 are tightened into the threaded holes of the first insertion member 11, the head portions of the screws 13 apply the pressing forces for pressing the insertion body 15 against the elevator rope 8 to the second pressurizing surfaces 124.

Further, in the first and second embodiments, the bottom surfaces of the first stepped portions 113 being the recessed portions correspond to the first pressurizing surfaces 114. However, it is not always required that the recessed portions be formed in the first insertion member 11. For example, a flat surface that is parallel to the first rope-side opposing surface 111 may be formed as the first pressurizing surface on the rear end portion of the first insertion member 11 in the longitudinal direction. In this case, the first pressurizing surface is formed as a flat surface continuous from the first housing-side opposing surface 112. Even in this manner, a space can be formed between the first pressurizing surface and the first receiving surface 102a. Thus, the pressing forces for pressing the insertion body 15 against the elevator rope 8 can be applied to the first pressurizing surface by the pressing portions.

Further, in the first and second embodiments, the bottom surfaces of the second stepped portions 123 being the recessed portions correspond to the second pressurizing surfaces 124. However, it is not always required that the recessed portions be formed in the first insertion member 11. For example, a flat surface that is parallel to the second rope-side opposing surface 121 may be formed as the second pressurizing surface on the rear end portion of the second insertion member 12 in the longitudinal direction. In this case, the second pressurizing surface is formed as a flat surface continuous from the second housing-side opposing surface 122. Even in this manner, a space can be formed between the second pressurizing surface and the second receiving surface 103a. Thus, the pressing forces for pressing the insertion body 15 against the elevator rope 8 can be applied to the second pressurizing surface by the pressing portions.

### Third Embodiment

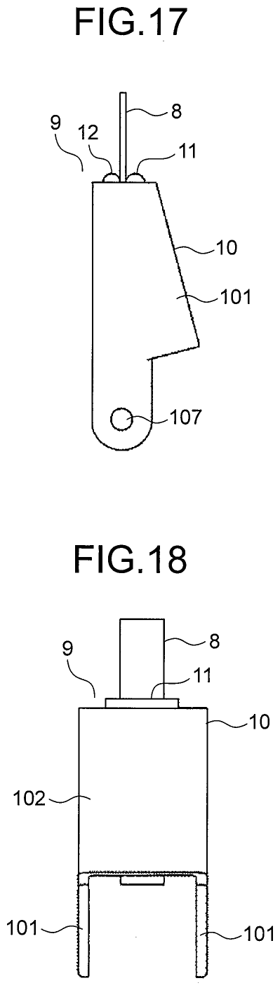

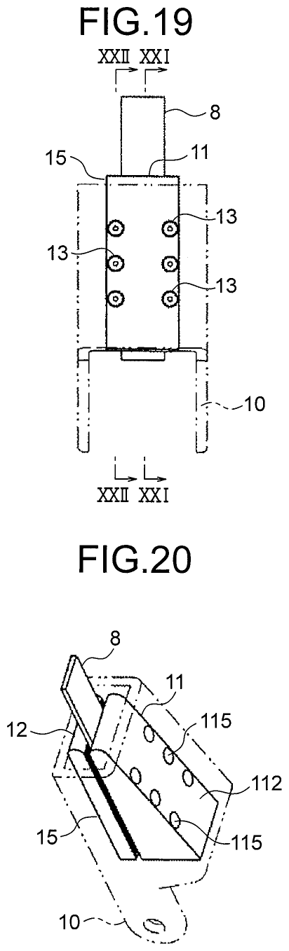

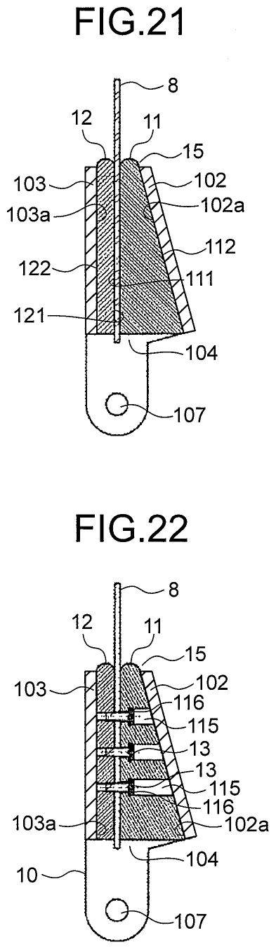

FIG. 16 is a perspective view for illustrating the first terminal structure 9 corresponding to an elevator rope terminal structure according to a third embodiment of the present invention. FIG. 17 is a front view for illustrating the first terminal structure 9 of FIG. 16. FIG. 18 is a side view for illustrating the first terminal structure 9 of FIG. 17. FIG. 19 is a side view for illustrating an inside of the first terminal structure 9 of FIG. 18. FIG. 20 is a perspective view for illustrating the inside of the first terminal structure 9 of FIG. 16. FIG. 21 is a sectional view taken along the line XXI-XXI of FIG. 19. FIG. 22 is a sectional view taken along the line XXII-XXII of FIG. 19.

The housing 10 is a single member. Specifically, the pair of parallel plates 101, the first receiving plate 102, and the second receiving plate 103 of the housing 10 are formed by integral molding so as to be disassemblable. In this example, the housing 10 is a cast molded member.

The first receiving surface 102a is inclined from the insertion body port of the through hole 104 toward the rope passage port of the through hole 104 in a direction closer to the axis of the housing 10. The second receiving surface 103a is arranged along the axis of the housing 10. With the arrangement described above, the housing 10 has an asymmetric shape having one projecting side.

A plurality of countersunk holes 115, each having a circular sectional shape, are formed in both end portions of the first insertion member 11 in the width direction. The countersunk holes 115 are arranged so as to be spaced apart from each other in the longitudinal direction of the elevator rope 8. Each of the countersunk holes 115 is a recessed portion, which is recessed from the first housing-side opposing surface 112 side toward the first rope-side opposing surface 111. A depth direction of each of the countersunk holes 115 matches the thickness direction of the first insertion member 11.

Further, a bottom surface of each of the countersunk holes 115 is formed in the first insertion member 11 as a pressurizing surface 116. As a result, positions of the pressurizing surfaces 116 are closer to the first rope-side opposing surface 111 than a position of the first housing-side opposing surface 112. The pressurizing surfaces 116 are parallel to the first rope-side opposing surface 111. The pressurizing surfaces 116 are apart from the inner surface of the through hole 104. As a result, a space inside each of the countersunk holes 115 is formed between the pressurizing surface 116 and the inner surface of the through hole 104.

The second housing-side opposing surface 122 is parallel to the second rope-side opposing surface 121. As a result, the second insertion member 12 has a flat plate-like shape. In this example, a thickness of the second insertion member 12 is smaller than a thickness of the first insertion member 11 at any position in the longitudinal direction of the insertion body 15. The second rope-side opposing surface 121 is in contact with the second rope surface of the elevator rope 8. The second housing-side opposing surface 122 is in contact with the second receiving surface 103a. With the shape and arrangement described above, the elevator rope 8 inserted in the through hole 104 is arranged so as to be inclined with respect to the first receiving surface 102a and in parallel to the second receiving surface 103a.

A plurality of run-through holes passing from the pressurizing surfaces 116 to reach the first rope-side opposing surface 111 are formed in the first insertion member 11. An inner diameter of each of the run-through holes is smaller than an inner diameter of each of the countersunk holes 115. A plurality of threaded holes passing from the second rope-side opposing surface 121 to reach the second housing-side opposing surface 122 are formed in the second insertion member 12.

The screws 13 are mounted into the threaded holes of the second insertion member 12 under a state in which the screws 13 are inserted through the run-through holes of the first insertion member 11. The screws 13 are arranged so as to be spaced apart from each other in the longitudinal direction of the insertion body 15. Further, the screws 13 are arranged within the set range of the insertion body 15 in a longitudinal direction of the insertion body 15. In this example, the set range in which the screws 13 are arranged corresponds to a range from the rear end portion of the insertion body 15 in the longitudinal direction to the position closer to the distal end portion of the insertion body 15 in the longitudinal direction with respect to the center position of the insertion body 15.

Further, as illustrated in FIG. 19, the screws 13 are arranged at positions outside the region of the elevator rope 8 when viewed along the thickness direction of the elevator rope 8. With the arrangement described above, the screws 13 are arranged without passing through the elevator rope 8. Further, the screws 13 are tightened into the threaded holes of the second insertion member 12. The screws 13 fasten the elevator rope 8 and the insertion body 15 together under a state in which the screws 13 are tightened into the threaded holes of the second insertion member 12.

The screws 13 fasten the elevator rope 8 and the insertion body 15 together to press the insertion body 15 against the elevator rope 8. In this manner, each of the screws 13 applies the pressing force to the insertion body 15 at a position outside the region of the elevator rope 8 when viewed along the thickness direction of the elevator rope 8. Further, each of the screws 13 applies the pressing force to the insertion body 15 in the direction of causing the first insertion member 11 and the second insertion member 12 to approach each other. The elevator rope 8 is held between the first insertion member 11 and the second insertion member 12 with the pressing forces applied to the insertion body 15 through the tightening of the screws 13.

The screws 13 are arranged so that head portions thereof are located in spaces inside the countersunk holes 115. Further, the head portions of the screws 13 apply the pressing forces for pressing the insertion body 15 against the elevator rope 8 to the first pressurizing surfaces 116 through the tightening of the screws 13 into the threaded holes of the second insertion member 12. Other configurations of the first terminal structure 9 are the same as those of the first terminal structure 9 in the first embodiment. Further, a configuration of the second terminal structure 20 corresponding to the elevator rope terminal structure is the same as the configuration of the first terminal structure 9. Other configurations are the same as those in the first embodiment.

In the first terminal structure 9 and the second terminal structure 20 described above, the second housing-side opposing surface 122 is parallel to the second rope-side opposing surface 121. Thus, the second insertion member 12 can be formed to have a flat plate-like shape. As a result, a dimension of the second insertion member 12 in the thickness direction can be reduced, and hence the reduction in size of the housing 10 can be achieved. Further, the housing 10 can be formed in an asymmetric shape. Thus, when the housing 10 is arranged with a non-projecting side of the housing 10 being appropriately selected, interference of the housing 10 with another device can be avoided.

Further, the bottom surfaces of the plurality of countersunk holes 115 are formed in the first insertion member 11 as the pressurizing surfaces 116. Thus, a space for securing the pressuring surfaces 116 in the first insertion member 11 can be reduced. As a result, an area of the first housing-side opposing surface 112 can be increased, and hence the insertion body 15 can be made less liable to come off the through hole 104.

Further, the plurality of countersunk holes 115 are formed in the first insertion member 11. Thus, a depth of each of the countersunk holes 115 can be set to be large. Specifically, because of the wedge-like shape of the first insertion member 11, a thickness of at least a part of the first insertion member 11 is larger than the thickness of the second insertion member 12. Thus, the depth of each of the countersunk holes 115 can be secured by forming the countersunk holes 115 in a portion of the first insertion member 11, which has a large thickness. As a result, the head portions of the screws 13 can be more reliably arranged in the spaces of the countersunk holes 115, and hence the interference of the head portions of the screws 13 with the inner surface of the through hole 104 can be more reliably avoided.

In the above-mentioned example, the plurality of countersunk holes 115 are formed in the first insertion member 11. However, the plurality of countersunk holes 115 may be formed in the second insertion member 12. In this case, the pressurizing surfaces 116 corresponding to the bottom surfaces of the countersunk holes 115 are formed in the second insertion member 12. Further, in this case, the plurality of run-through holes, through which the screws 13 are inserted, are formed in the second insertion member 12, and the plurality of threaded holes, into which the screws 13 are mounted, are formed in the first insertion member 11. Even in this manner, when the screws 13, which are inserted through the run-through holes of the second insertion member 12, are tightened into the threaded holes of the first insertion member 11, the insertion body 15 can be pressed against the elevator rope 8.

### Fourth Embodiment

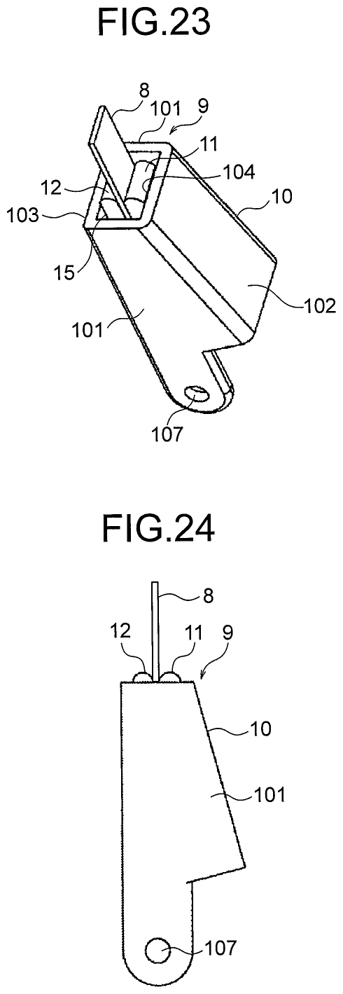

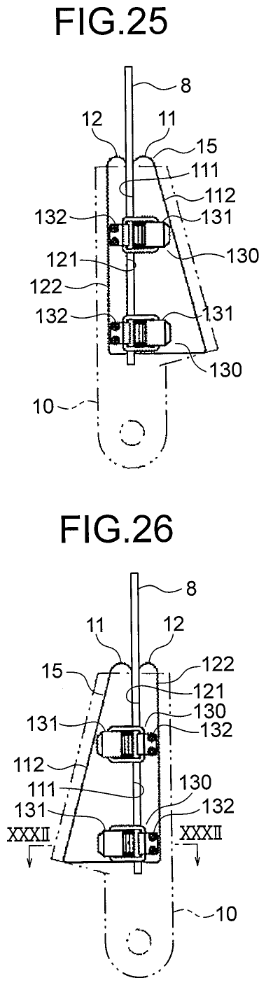

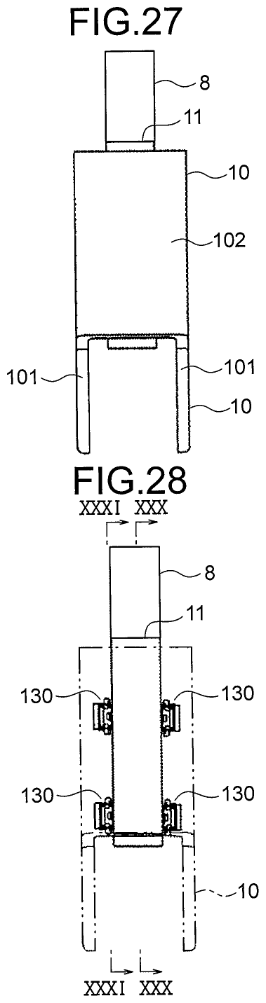

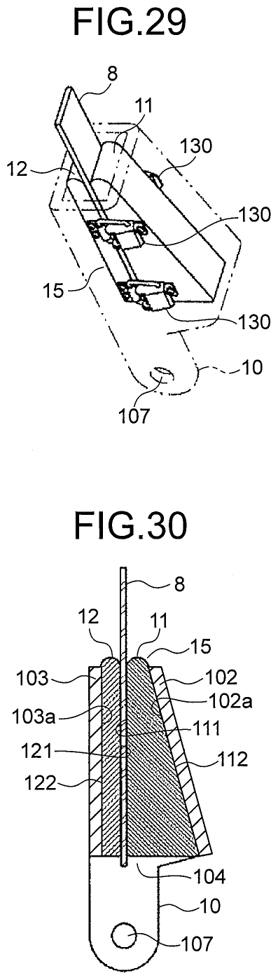

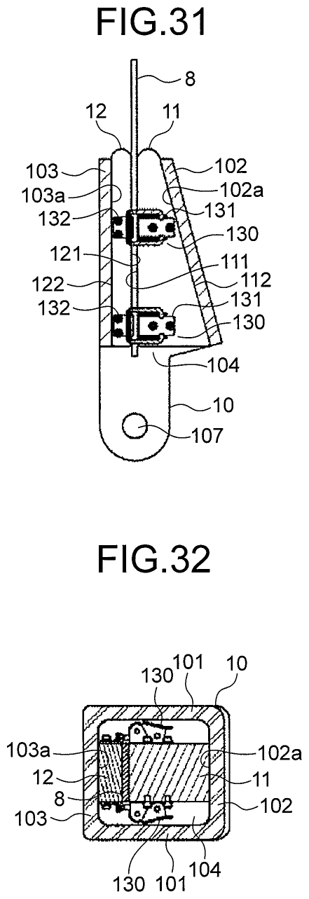

FIG. 23 is a perspective view for illustrating the first terminal structure 9 corresponding to an elevator rope terminal structure according to a fourth embodiment of the present invention. FIG. 24 is a front view for illustrating the first terminal structure 9 of FIG. 23. FIG. 25 is a front view for illustrating an inside of the first terminal structure 9 of FIG. 24. FIG. 26 is a back view for illustrating the inside of the first terminal structure 9 of FIG. 24. FIG. 27 is a side view for illustrating the first terminal structure 9 of FIG. 24. FIG. 28 is a side view for illustrating the inside of the first terminal structure 9 of FIG. 27. FIG. 29 is a perspective view for illustrating the inside of the first terminal structure 9 of FIG. 23. FIG. 30 is a sectional view taken along the line XXX-XXX of FIG. 28. FIG. 31 is a sectional view taken along the line XXXI-XXXI of FIG. 28. FIG. 32 is a sectional view taken along the line XXXII-XXXII of FIG. 26.

The dimension of the insertion body 15 in the width direction is the same as the dimension of the elevator rope 8 in the width direction. Further, both end surfaces of the first insertion member 11 in the width direction and both end surfaces of the second insertion member 12 in the width direction are apart from the inner surface of the through hole 104, as illustrated in FIG. 32. With the arrangement described above, spaces are formed between both end surfaces of the first insertion member 11 in the width direction and both end surfaces of the second insertion member 12 in the width direction and the inner surface of the through hole 104.

In the spaces formed between both end surfaces of the first insertion member 11 in the width direction and both end surfaces of the second insertion member 12 in the width direction and the inner surface of the through hole 104, a plurality of clips 130 corresponding to the pressing portions are arranged. In this example, two clips 130 are arranged on each of the sides of the insertion body 15 in the width direction. The clips 130 are provided on the insertion body 15.

Each of the clips 130 includes a clip main body 131 and a fixed hook 132. The clip main body 131 is fixed to an end surface of the first insertion member 11 in the width direction. The fixed hook 132 is fixed to an end surface of the second insertion member 12 in the width direction.

The clip main body 131 includes a movable hook and an operation lever. The movable hook can be engaged with the fixed hook 132. The operation lever is configured to move the movable hook relative to the first insertion member 11. When the fixed hook 132 with which the movable hook is engaged is pulled by the clip main body 131 through an operation of the operation lever, each of the clips 130 presses the insertion body 15 against the elevator rope 8. In this manner, each of the clips 130 applies a pressing force to the insertion body 15 at a position outside the region of the elevator rope 8 when viewed along the thickness direction of the elevator rope 8. Further, each of the clips 130 applies the pressing force for causing the first insertion member 11 and the second insertion member 12 to approach each other to the insertion body 15. Thus, the elevator rope 8 is held between the first insertion member 11 and the second insertion member 12 with the pressing forces of the clips 130.

Each of the clips 130 maintains a state in which the insertion body 15 is pressed against the elevator rope 8 by maintaining a state in which the fixed hook 132 engaged with the movable hook is pulled toward the clip main body 131. In this manner, the state in which the insertion body 15 is held over the elevator rope 8 is maintained regardless of whether or not the insertion body 15 is inserted in the through hole 104. Other configurations of the first terminal structure 9 are the same as those of the first terminal structure 9 in the third embodiment. Further, a configuration of the second terminal structure 20 corresponding to the elevator rope terminal structure is the same as the configuration of the first terminal structure 9. Other configurations are the same as those in the first embodiment.

In the first terminal structure 9 and the second terminal structure 20 described above, the plurality of clips 130, each including the clip main body 131 and the fixed hook 132, are used as the pressing portions. Thus, when the clip main body 131 engaged with the fixed hook 132 only pulls the fixed hook 132, work for pressing the insertion body 15 against the elevator rope 8 can easily be performed.

A set range in which the clips 130 are arranged may be set on the rear end portion side of the insertion body 15 in the longitudinal direction with respect to the center position of the insertion body 15 in the longitudinal direction. In this manner, as in the second embodiment, breaking of the elevator rope 8 at the distal end portion of the insertion body 15 in the longitudinal direction can be suppressed. Further, the spaces in which the clips 130 are arranged can be more reliably secured.

Further, in the above-mentioned example, the dimension of the insertion body 15 in the width direction is the same as the dimension of the elevator rope 8 in the width direction. However, the dimension of the insertion body 15 in the width direction may be set to be larger than the dimension of the elevator rope 8 in the width direction. With the dimensions described above, even when the position of the insertion body 15 is shifted in the width direction of the elevator rope 8, the insertion body 15 can be more reliably pressed against the elevator rope 8.

Still further, in the above-mentioned example, the clip main body 131 is arranged on the first insertion member 11, and the fixed hook 132 is arranged on the second insertion member 12. However, the fixed hook 132 may be arranged on the first insertion member 11, and the clip main body 131 may be arranged on the second insertion member 12.

### Fifth Embodiment

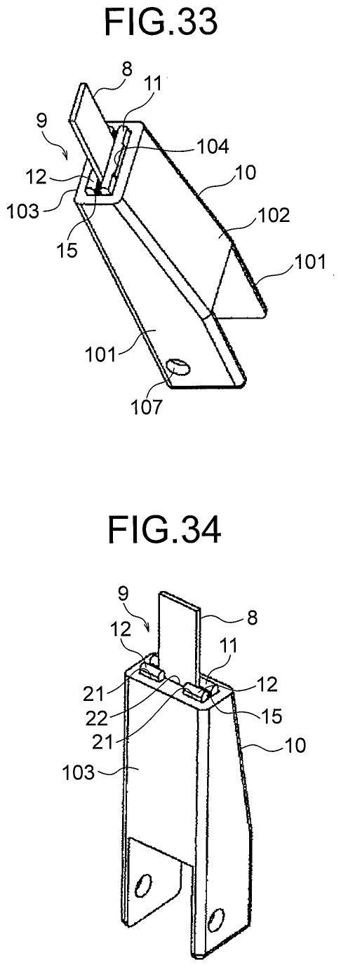

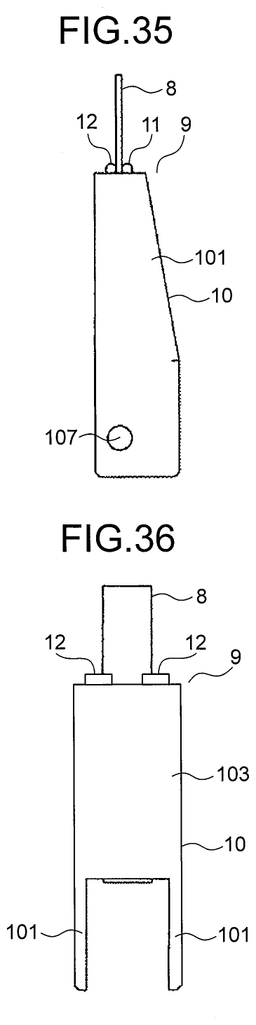

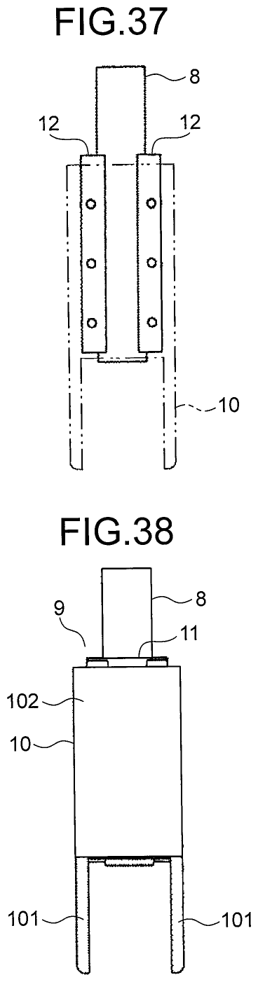

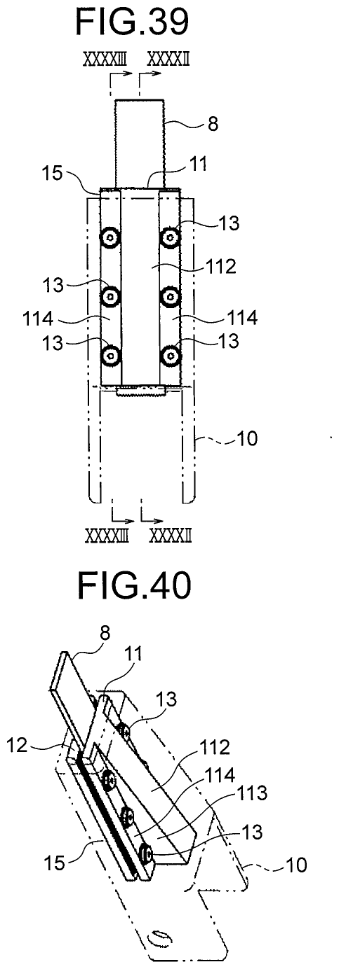

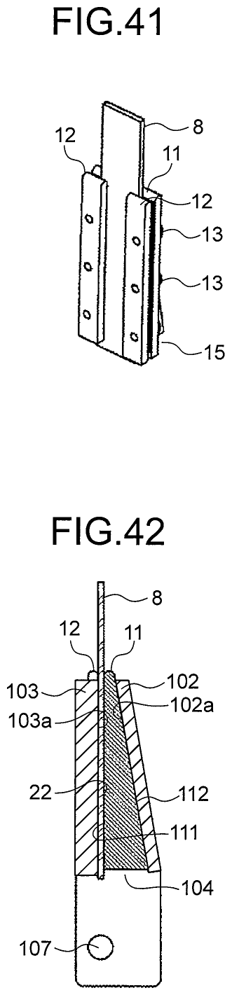

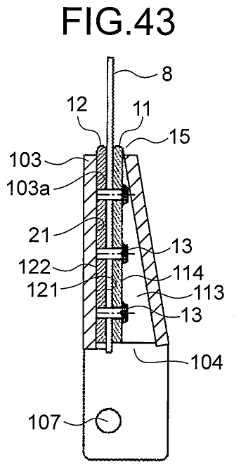

FIG. 33 is a perspective view for illustrating the first terminal structure 9 corresponding to an elevator rope terminal structure according to a fifth embodiment of the present invention. FIG. 34 is a perspective view for illustrating a state in which the first terminal structure 9 of FIG. 33 is viewed from another side. FIG. 35 is a front view for illustrating the first terminal structure 9 of FIG. 33. FIG. 36 is a side view for illustrating the first terminal structure 9 when viewed from the left side of FIG. 35. FIG. 37 is a side view for illustrating an inside of the first terminal structure 9 of FIG. 36. FIG. 38 is a side view for illustrating the first terminal structure 9 when viewed from the right side of FIG. 35. FIG. 39 is a side view for illustrating the inside of the first terminal structure 9 of FIG. 38. FIG. 40 is a perspective view for illustrating the inside of the first terminal structure 9 of FIG. 33. FIG. 41 is a perspective view for illustrating the inside of the first terminal structure 9 of FIG. 34. FIG. 42 is a sectional view taken along the line XXXXII-XXXXII of FIG. 39. FIG. 43 is a sectional view taken along the line XXXXIII-XXXXIII of FIG. 39.

The insertion body 15 includes the first insertion member 11 and a pair of second insertion members 12. A configuration of the first insertion member 11 is the same as that in the first embodiment.

The pair of second insertion members 12 are arranged between the elevator rope 8 and the second receiving surface 103a so as to extend along the longitudinal direction of the elevator rope 8. Further, the pair of second insertion members 12 are arranged apart from each other in the width direction of the elevator rope 8. With the arrangement described above, one end portion of the elevator rope 8 in the width direction is sandwiched between one end portion of the first insertion member 11 in the width direction and one of the second insertion members 12. The other end portion of the elevator rope 8 in the width direction is sandwiched between the other end portion of the first insertion member 11 in the width direction and the other one of the second insertion members 12.

Each of the second insertion members 12 includes, as illustrated in FIG. 43, the second rope-side opposing surface 121 and the second housing-side opposing surface 122. The second housing-side opposing surface 122 is formed on a side opposite to the second rope-side opposing surface 121 in the thickness direction of the second insertion member 12. The second housing-side opposing surface 122 is parallel to the second rope-side opposing surface 121. In this manner, the second insertion member 12 has a flat plate-like shape.

A plurality of threaded holes passing from the second rope-side opposing surface 121 to reach the second housing-side opposing surface 122 are formed in each of the second insertion members 12. The plurality of threaded holes are formed in each of the insertion members 12 so as to be spaced apart from each other in the longitudinal direction of the second insertion members 12.

The screws 13 corresponding to the pressing portions are mounted in the threaded holes of the second insertion members 12 under a state in which the screws 13 are inserted through the run-through holes of the first insertion member 11. As in the first embodiment, the screws 13 fasten the elevator rope 8 and the insertion body 15 together under a state in which the screws 13 are tightened into the threaded holes of the second insertion members 12. Both end portions of the elevator rope 8 in the width direction are held between the first insertion member 11 and the second insertion members 12 with the pressing forces applied to the insertion body 15 by fastening of the screws 13.

The second receiving surface 103a includes, as illustrated in FIG. 42 and FIG. 43, a pair of insertion-body contact surface portions 21 and a rope contact surface portion 22. The pair of insertion-body contact surface portions 21 are apart from each other in the width direction of the elevator rope 8. The rope contact surface portion 22 is arranged between the pair of insertion-body contact surface portions 21. The rope contact surface portion 22 and the pair of insertion-body contact surface portions 21 are formed so as to extend along the longitudinal direction of the elevator rope 8. Further, the rope contact surface portion 22 is formed at a position closer to the first receiving surface 102a than positions of the pair of insertion-body contact surface portions 21.

The second rope-side opposing surfaces 121 of the second insertion members 12 are in contact with both end portions of the second rope surface of the elevator rope 8 in the width direction. The second housing-side opposing surfaces 122 of the second insertion members 12 are in contact with the pair of insertion-body contact surface portions 21 of the second receiving surface 103a, respectively. The rope contact surface portion 22 of the second receiving surface 103a is in contact with an intermediate portion of the second rope surface of the elevator rope 8 in the width direction of the elevator rope 8. Thus, the second rope-side opposing surfaces 121 of the second insertion members 12 and the rope contact surface portion 22 of the second receiving surface 103a are in contact with the second rope surface of the elevator rope 8. Other configurations of the first terminal structure 9 are the same as the configurations of the first terminal structure 9 in the third embodiment. Further, a configuration of the second terminal structure 20 corresponding to the elevator rope terminal structure is the same as the configuration of the first terminal structure 9. Other configurations are the same as those in the first embodiment.

In the first terminal structure 9 and the second terminal structure 20 described above, the rope contact surface portion 22 of the second receiving surface 103a is in contact with the elevator rope 8. Thus, the elevator rope 8 and the insertion body 15 can be held inside the through hole 104 by using not only a frictional force acting between the housing 10 and each of the second insertion members 12 but also a friction force acting between the housing 10 and the elevator rope 8. As a result, the frictional force of the housing 10 on each of the elevator rope 8 and the second insertion members 12, which are made of different materials, can be adjusted. Hence, the fictional forces required to hold the elevator rope 8 and the insertion body 15 inside the through hole 104 can easily be adjusted.

In the above-mentioned example, the pair of insertion-body contact surface portions 21 of the second receiving surface 103a are in contact with the second insertion members 12. However, the second insertion members 12 may be omitted. In this case, only the first insertion member 11 is fastened to the elevator rope 8 with use of the plurality of screws 13. Further, in this case, the screws 13 are tightened into the threaded holes of the first insertion member 11 under a state in which both end portions of the first elevator rope 8 in the width direction are sandwiched between the head portions of the screws 13 and the first insertion member 11. As a result, the first insertion member 11 is pressed against the elevator rope 8. Even in this manner, the insertion body 15 can be held over the elevator rope 8 regardless of the presence or absence of the housing 10. Hence, the elevator rope 8 and the insertion body 15 can be held between the first receiving surface 102a and the rope contact surface portion 22.

Further, in the above-mentioned example, the plurality of run-through holes, through which the screws 13 are inserted, are formed in the first insertion member 11, and the plurality of threaded holes, into which the screws 13 are mounted, are formed in the second insertion members 12. However, the plurality of run-through holes, through which the screws 13 are inserted, may be formed in the second insertion members 12, and the plurality of threaded holes, into which the screws 13 are mounted, may be formed in the first insertion member 11. Even in this manner, the insertion body 15 can be pressed against the elevator rope 8 by tightening the screws 13 inserted through the run-through holes of the second insertion members 12 into the threaded holes of the first insertion member 11.

Further, in the first to third and fifth embodiments, the screws 13 are used as the pressing portions configured to press the insertion body 15 against the elevator rope 8. However, each of the pressing portions configured to press the insertion body 15 against the elevator rope 8 may include a screw and a nut. In this case, a plurality of run-through holes are formed in each of the first insertion member 11 and the second insertion member 12. Further, in this case, the nuts of the pressing portions are mounted to the screws of the pressing portions, which are sequentially inserted through the run-through holes of the first insertion member 11 and the second insertion member 12. The first insertion member 11, the second insertion member 12, and the elevator rope 8 are fastened between the head portions of the screws and the nuts by tightening the nuts into the screws. The screws and the nuts fasten the first insertion member 11, the second insertion member 12, and the elevator rope 8 together to press the insertion body 15 against the elevator rope 8. Even in this manner, the state in which the insertion body 15 is pressed against the elevator rope 8 can be maintained with a simple configuration.

When each of the pressing portions includes the screw and the nut, a spring washer, which is an elastic member, may be provided at at least one of a position between the head portion of the screw and the insertion body 15 or a position between the nut and the insertion body 15. In this manner, the screw and the nut, which fasten the elevator rope 8 and the insertion body 15 together, can be made less liable to loosen. In this manner, the state in which the insertion body 15 is pressed against the elevator rope 8 can be more reliably maintained.

Still further, in the first to third and fifth embodiments, the head portions of the screws 13 are in contact with the insertion body 15. However, a spring washer, which is an elastic member, may be provided between the head portion of each of the screws 13 and the insertion body 15. In this manner, the screws 13, which fasten the elevator rope 8 and the insertion body 15 together, can be made less liable to loosen. As a result, the state in which the insertion body 15 is pressed against the elevator rope 8 can be more reliably maintained.

Still further, in the first to third and fifth embodiments, the screws 13 are arranged outside the elevator rope 8 in the width direction. However, the screws 13 may pass through the elevator rope 8.

Still further, in the third to fifth embodiments, the second insertion member 12 has a flat plate-like shape. However, the second insertion member 12 may have a wedge-like shape. Specifically, in the second insertion member 12, the distance between the housing-side opposing surface 122 and the second rope-side opposing surface 121 may continuously decrease toward the rope passage port of the through hole 104.

Still further, in each of the embodiments described above, the car 3 and the counterweight 4 are suspended in the 1:1 roping system. However, the car 3 and the counterweight 4 may be suspended in a 2:1 roping system. In this case, the elevator ropes 8 are wound around a car suspension sheave provided to the car 3 and a counterweight suspension sheave provided to the counterweight 4. The first terminal structures 9 and the second terminal structures 20 are mounted to an upper part of the hoistway 1.

Still further, in each of the embodiments described above, the first terminal structure 9 and the second terminal structure 20 are used as the elevator rope terminal structures for the elevator including the machine room provided above the hoistway. However, the first terminal structure 9 and the second terminal structure 20 may be used as the elevator rope terminal structures for a machine room-less elevator without a machine room.

### REFERENCE SIGNS LIST

8 elevator rope, 9 first terminal structure (elevator rope terminal structure), 10 housing, 11 first insertion member, 12 second insertion member, 13 screw (pressing portion), 15 insertion body, 20 second terminal structure (elevator rope terminal structure), 102a first receiving surface, 103a second receiving surface, 104 through hole, 111 first rope-side opposing surface, 112 first housing-side opposing surface, 113 first stepped portion (recessed portion), 114 first pressurizing surface (pressurizing surface), 115 countersunk hole (recessed portion), 116 pressurizing surface, 121 second rope-side opposing surface, 122 second housing-side opposing surface, 123 second stepped portion (recessed portion), 124 second pressurizing surface (pressurizing surface), 130 clip (pressing portion), 131 clip main body, 132 fixed hook.

1. An elevator rope terminal structure, comprising:
an insertion body to be held in contact with an elevator rope having a flat sectional shape; and
a housing which has a through hole with a rope passage port into which the elevator rope is to be inserted from an outside to an inside of the through hole, and is configured to hold the elevator rope and the insertion body inside the through hole,
wherein the through hole has an inner surface including a first receiving surface and a second receiving surface which are to be positioned on both sides of the elevator rope in a thickness direction of the elevator rope,
wherein the insertion body includes:
a first insertion member which is to be held in contact with the first receiving surface and the elevator rope; and
a second insertion member which is to be held in contact with the second receiving surface and the elevator rope,
the elevator rope terminal structure comprising:
pressing portions configured to apply pressing forces to the first insertion member and the second insertion member in a direction of causing the first insertion member and the second insertion member to approach each other to press the insertion body against the elevator rope so as to integrate the insertion body and the elevator rope with each other.

2.-17. (canceled)

18. An elevator rope terminal structure, comprising:
an insertion body to be held in contact with an elevator rope having a flat sectional shape; and
a housing which has a through hole with a rope passage port into which the elevator rope is to be inserted from an outside to an inside of the through hole, and is configured to hold the elevator rope and the insertion body inside the through hole,
wherein the through hole has an inner surface including receiving surfaces to be positioned on both sides of the elevator rope in a thickness direction of the elevator rope,
the elevator rope terminal structure comprising:
pressing portions configured to press the insertion body against the elevator rope with use of surfaces of the insertion body which are recessed from housing-side opposing surfaces of the insertion body, the housing-side opposing surfaces being in contact with the receiving surfaces, as pressurizing surfaces.

19. An elevator rope terminal structure, comprising:
an insertion body to be held in contact with an elevator rope having a flat sectional shape; and
a housing which has a through hole with a rope passage port into which the elevator rope is to be inserted from an outside to an inside of the through hole, and is configured to hold the elevator rope and the insertion body inside the through hole,
wherein the through hole has an inner surface including receiving surfaces to be positioned on both sides of the elevator rope in a thickness direction of the elevator rope,
the elevator rope terminal structure comprising:
pressing portions which are provided so as to be located in spaces formed between end surfaces of the insertion body in a width direction of the insertion body and the inner surface of the through hole, and are configured to press the insertion body against the elevator rope.

20. The elevator rope terminal structure according to claim 18, wherein the insertion body includes a first insertion member to be arranged between the elevator rope and a first receiving surface corresponding to one of the receiving surfaces.

21. The elevator rope terminal structure according to claim 20,
wherein the inner surface of the through hole includes a second receiving surface corresponding to the other one of the receiving surfaces, and
wherein the second receiving surface is to be held in contact with the elevator rope.

22. The elevator rope terminal structure according to claim 20, wherein the insertion body includes a second insertion member to be arranged between the elevator rope and the second receiving surface corresponding to the other one of the receiving surfaces.

23. The elevator rope terminal structure according to claim 21, wherein the insertion body includes a second insertion member to be arranged between the elevator rope and the second receiving surface corresponding to the other one of the receiving surfaces.

24. The elevator rope terminal structure according to claim 22, wherein the pressing portions are configured to press the insertion body against the elevator rope by applying pressing forces to the insertion body in a direction of causing the first insertion member and the second insertion member to approach each other.

25. The elevator rope terminal structure according to claim 20,
wherein the first insertion member has a first rope-side opposing surface which is to be held in contact with the elevator rope, and a first housing-side opposing surface which is to be held in contact with the first receiving surface, and
wherein a distance between the first housing-side opposing surface and the first rope-side opposing surface decreases toward the rope passage port.

26. The elevator rope terminal structure according to claim 1,
wherein the first insertion member has a first rope-side opposing surface which is to be held in contact with the elevator rope, and a first housing-side opposing surface which is to be held in contact with the first receiving surface, and
wherein a distance between the first housing-side opposing surface and the first rope-side opposing surface decreases toward the rope passage port.

27. The elevator rope terminal structure according to claim 26,
wherein the second insertion member has a second rope-side opposing surface which is to be held in contact with the elevator rope, and a second housing-side opposing surface which is to be held in contact with the second receiving surface, and
wherein a distance between the second housing-side opposing surface and the second rope-side opposing surface decreases toward the rope passage port.

28. The elevator rope terminal structure according to claim 1,
wherein the second insertion member has a second rope-side opposing surface which is to be held in contact with the elevator rope, and a second housing-side opposing surface which is to be held in contact with the second receiving surface, and
wherein the second housing-side opposing surface is parallel to the second rope-side opposing surface.

29. The elevator rope terminal structure according to claim 1,
wherein the insertion body has pressurizing surfaces formed apart from the inner surface of the through hole, and
wherein the pressing portions are configured to apply pressing forces for pressing the insertion body against the elevator rope to the pressurizing surfaces.

30. The elevator rope terminal structure according to claim 18,
wherein the insertion body has recessed portions, and
wherein the pressurizing surfaces are bottom surfaces of the recessed portions.

31. The elevator rope terminal structure according to claim 30, wherein the recessed portions are formed along a longitudinal direction of the elevator rope.

32. The elevator rope terminal structure according to claim 1, wherein the pressing portions are provided at positions outside a region of the elevator rope when viewed along the thickness direction of the elevator rope, and are configured to press the insertion body against the elevator rope by applying pressing forces to the insertion body.

33. The elevator rope terminal structure according to claim 1, wherein a dimension of the insertion body in a width direction of the insertion body is larger than a dimension of the elevator rope in a width direction of the elevator rope.

34. The elevator rope terminal structure according to claim 1,
wherein each of the pressing portions includes a screw, and
wherein the screws are configured to press the insertion body against the elevator rope by fastening the elevator rope and the insertion body together.

35. The elevator rope terminal structure according to claim 1,
wherein each of the pressing portions includes a screw and a nut to be mounted to the screw, and
wherein the screws and the nuts are configured to press the insertion body against the elevator rope by fastening the elevator rope and the insertion body together.

36. The elevator rope terminal structure according to claim 34, further comprising an elastic member provided between a head portion of each of the screws and the insertion body.
